(19) United States
(12) Patent Application Publication
(10) Pub. No.: US 2016/0075290 A1
(43) Pub. Date: Mar. 17, 2016

(54) VEHICLE TRIM COMPONENT

(71) Applicant: Yanfeng US Automotive Interior Systems I LLC, Plymouth, MI (US)

(72) Inventor: Michael R. CATLIN, Holland, MI (US)

(73) Assignee: Yanfeng US Automotive Interior Systems I LLC, Plymouth, MI (US)

(21) Appl. No.: 14/952,029

(22) Filed: Nov. 25, 2015

Related U.S. Application Data
(63) Continuation-in-part of application No. PCT/US2014/039804, filed on May 28, 2014.
(60) Provisional application No. 61/829,507, filed on May 31, 2013.

(51) Int. Cl. B60R 13/02; B05D 7/12; C14C 11/00; B05D 7/06; B05D 7/14; D06N 3/18; B05D 7/00; B05D 7/02

(52) U.S. Cl. CPC B60R 13/02; B05D 7/54; B05D 7/12; B05D 7/02; B05D 7/06; B05D 7/14; D06N 3/183; C14C 11/003; C14C 11/006

(57) ABSTRACT

A vehicle trim component is prepared by a process that includes providing a cover on a plate, providing a first material layer on the cover, and providing a second material layer on the first material layer to form the vehicle trim component. The first material layer bonds to the cover as it solidifies. The second material layer bonds to the first material layer as it solidifies.

### CROSS-REFERENCE TO RELATED PATENT APPLICATIONS

This application is a continuation-in-part of PCT/US2014/039804 filed May 28, 2014 and claims priority from and the benefit of U.S. Provisional Patent Application Ser. No. 61/829,507, entitled “SYSTEM AND METHOD FOR FORMING A VEHICLE TRIM COMPONENT VIA ADDITIVE MANUFACTURING”, filed May 31, 2013, both of which are hereby incorporated by reference in their entireties.

### FIELD

The disclosure relates generally to vehicle trim components and methods for forming vehicle trim components.

### BACKGROUND

Certain vehicle trim components are formed by an additive manufacturing process, in which a printing head disposes material (e.g., in layers, in filaments, etc.) onto a platen to form a component having a desired shape. For example, certain additive manufacturing devices include a printing head having an extrusion nozzle configured to dispose multiple filaments of heated liquid material onto the platen in a desired pattern. As the liquid material cools and solidifies, a complete trim component is formed on the platen. A decorative layer (e.g., a laminate film, a fabric covering, a wood veneer, etc.) may be affixed to the trim component, establishing an aesthetically desirable show surface. The process of affixing the decorative layer to the trim component (e.g., via application of an adhesive, installation of fasteners, etc.) may be time consuming, significantly increasing the manufacturing costs of the component.

### SUMMARY

The present invention relates to a method of manufacturing a vehicle trim component. The method includes applying a show surface of a decorative layer to a support surface of a platen of an additive manufacturing device. The method also includes disposing material onto a rear surface of the decorative layer via a printing head of the additive manufacturing device to form the vehicle trim component.

The present invention also relates to a vehicle trim component prepared by a process. The process includes applying a show surface of a decorative layer to a support surface of a platen of an additive manufacturing device. The process also includes disposing material onto a rear surface of the decorative layer via a printing head of the additive manufacturing device to form the vehicle trim component.

The present invention further relates to an additive manufacturing device for forming a vehicle trim component. The additive manufacturing device includes a platen configured to support a decorative layer via contact between a support surface of the platen and a show surface of the decorative layer. The additive manufacturing device also includes a printing head configured to dispose material onto a rear surface of the decorative layer to form the vehicle trim component. In addition, the additive manufacturing device includes an attachment device configured to secure the decorative layer to the platen at least while the printing head disposes the material onto the rear surface of the decorative layer.

An aspect of the disclosure generally relates to a vehicle trim component which is prepared by a process that includes providing a cover on a plate, providing a first material layer on the cover, and providing a second material layer on the first material layer to form the vehicle trim component. The first material layer bonds to the cover as it solidifies. The second material layer bonds to the first material layer as it solidifies.

Another aspect of the disclosure generally relates to a method of manufacturing a vehicle trim component, which includes providing a cover on a plate, providing a first material layer on the cover, and providing a second material layer on the first material layer to form the vehicle trim component. The first material layer bonds to the cover as it solidifies. The second material layer bonds to the first material layer as it solidifies.

### DRAWINGS

FIG. 1 is a schematic perspective view of an exemplary embodiment of a vehicle that may include a trim component formed in accordance with an exemplary embodiment of the present invention.

FIG. 2 is a schematic perspective view of an exemplary embodiment of a part of the interior of the vehicle of FIG. 1.

FIG. 3 is a schematic view of an exemplary embodiment of a manufacturing device for forming a vehicle trim component.

FIG. 4 is a schematic cross-sectional view of an exemplary embodiment of a platen of a manufacturing device, including an adhesive layer configured to secure a decorative layer to the platen.

FIG. 5 is a schematic view of an exemplary embodiment of an electrostatic charging assembly configured to facilitate securing a decorative layer to a platen of a manufacturing device.

FIG. 6 is a schematic cross-sectional view of an exemplary embodiment of a platen of a manufacturing device, including a magnetic assembly configured to secure a decorative layer to the platen.

FIG. 7 is a schematic process flow diagram of an exemplary embodiment of a method of manufacturing a vehicle trim component.

### DETAILED DESCRIPTION

Referring generally to the figures, this application discloses various exemplary embodiments of vehicle trim components for use in vehicles and methods for producing the vehicle trim components.

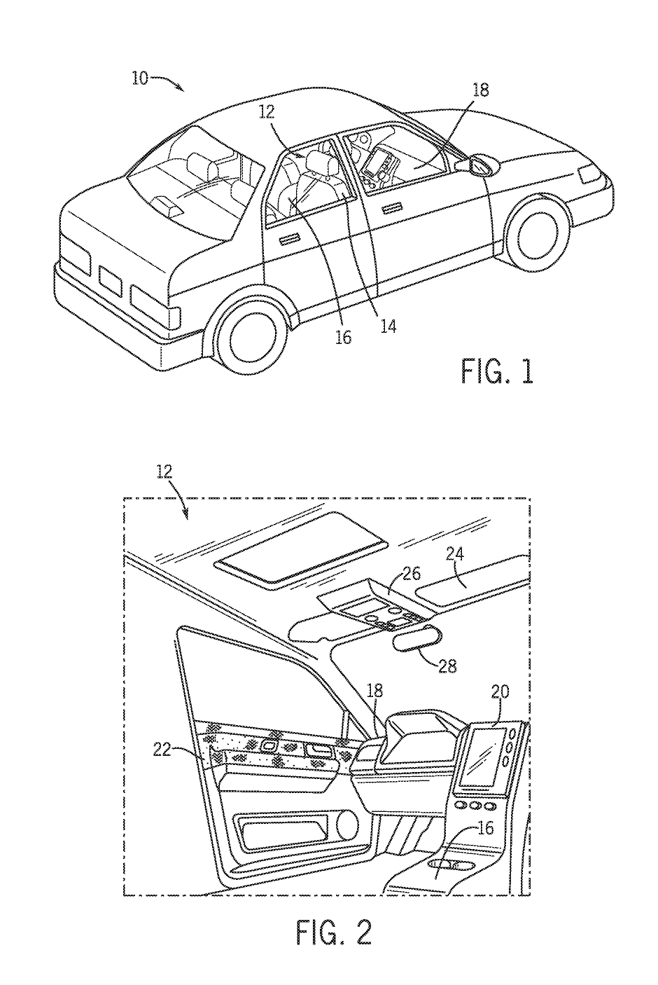

FIG. 1 is a schematic perspective view of an exemplary embodiment of a vehicle that may include a trim component formed by a manufacturing process. The vehicle 10 includes an interior 12 having a seat 14, a floor console 16, and an instrument panel 18. The seat 14, the floor console 16, the instrument panel 18, and/or other areas within the interior 12 may include a trim component formed by a manufacturing process. In certain exemplary embodiments, the manufacturing process includes applying a show surface of a cover, such as a decorative layer, to a support surface of a plate, such as a platen, of a manufacturing device. Next, material (e.g., heated liquid material) is disposed onto a rear surface of the decorative layer via the manufacturing device to form a vehicle trim component. During the manufacturing process, the material bonds to the decorative layer (e.g., as the heated liquid material cools and hardens), forming a unitary component having an aesthetically desirable show surface. The need for a process of coupling a decorative layer to a preformed component is eliminated. As a result, the manufacturing costs associated with forming a vehicle trim component having an aesthetically desirable show surface may be significantly reduced.

FIG. 2 is a schematic perspective view of an exemplary embodiment of a part of the interior of the vehicle of FIG. 1. The vehicle interior 12 includes multiple interior components, such as the floor console 16, the instrument panel 18, a center console 20, a door panel 22, sun visors 24, an overhead console 26, and a rearview mirror 28. At least a portion of certain interior components (e.g., the floor console 16, the instrument panel 18, the center console 20, the door panel 22, the sun visors 24, the overhead console 26, and/or the rearview mirror 28, etc.) may be formed by a manufacturing device. In certain exemplary embodiments, the manufacturing device includes a plate, such as a platen, configured to support a cover, such as a decorative layer, via contact between a support surface of the platen and a show surface of the decorative layer. According to certain exemplary embodiments, the device may also include a printing head configured to dispose material (e.g., heated liquid material) onto a rear surface of the decorative layer to form a substrate. The material bonds to the decorative layer (e.g., as the heated liquid material cools and hardens). Forming the substrate behind the decorative layer substantially reduces the duration and/or costs associated with manufacturing an aesthetically desirable trim component, as compared to applying a decorative layer to a preformed substrate.

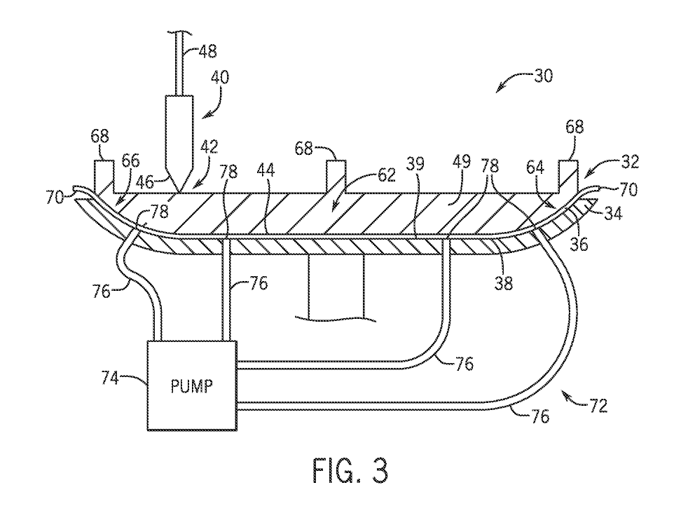

According to exemplary embodiments, the device for manufacturing the vehicle trim component can be at least one of an extrusion device, a laminated object manufacturing device, and/or a printing head of an additive manufacturing device. An exemplary embodiment of the invention will be explained in the context of an additive manufacturing device. FIG. 3 is a schematic view of an exemplary embodiment of an additive manufacturing device 30 for forming a vehicle trim component 32. According to an exemplary embodiment, the additive manufacturing device 30 includes a plate, such as a platen 34, configured to support a cover, such as a decorative layer 36, via contact between a support surface 38 of the platen 34 and a show surface 39 of the decorative layer 36. According to an exemplary embodiment, the platen 34 can be configured to define a shape of the formed vehicle trim component. According to an exemplary embodiment, the additive manufacturing device 30 also includes a printing head 40 configured to dispose material 42 onto a rear surface 44 of the decorative layer 36 to form the vehicle trim component 32. For example, according to an exemplary embodiment, the printing head 40 includes an extrusion nozzle 46 configured to dispose multiple filaments of heated liquid material onto the rear surface 44 of the decorative layer 36 in a desired pattern, thereby forming a substrate having a desired shape. As the liquid material cools and solidifies, the material 42 bonds to the decorative layer 36, thereby forming a unitary component. According to an exemplary embodiment, the printing head 40 includes a supply line 48 configured to supply the heated liquid material to the extrusion nozzle 46.

According to an exemplary embodiment, the material provided by the manufacturing device may be any polymeric material suitable for forming a substrate 49 of the vehicle trim component 32. For example, the material may include thermoset polymer including, for example, a two-part reactive material (e.g., polyisocyanate/polyol) that forms a thermoset polymer (e.g., polyurethane). The material may also include polyisocyanate, polyol, polyurethane, acrylonitrile butadiene styrene (ABS), polycarbonate (PC), high density polyethylene (HDPE), among other polymeric materials or combinations of polymeric materials (e.g., PC and ABS). While an extrusion-type additive manufacturing device is employed in the illustrated embodiment, other manufacturing devices may be utilized in alternative exemplary embodiments.

According to an exemplary embodiment, the manufacturing device can be configured to provide a first material layer on the cover, such as decorative layer 36, and then provide a second material layer on the first material layer to form the trim component. According to an exemplary embodiment, the first material layer bonds to the decorative layer 36 as it solidifies, and the second material layer bonds to the first material layer as it solidifies. According to an exemplary embodiment, the second material layer can comprise multiple material layers. According to an exemplary embodiment, the first material layer and/or the second material layer may comprise heated liquids and/or filaments. According to an exemplary embodiment, the second material layer is provided on the first material layer as at least one of filaments and/or layers in a pattern. According to exemplary embodiments, the first material layer and the second material layer may be the same or different materials.

According to an exemplary embodiment, the printing head 40 and/or the platen 34 is movable in multiple axes to facilitate formation of the trim component substrate 49. For example, the printing head 40 may translate along a lateral axis, along a longitudinal axis, and/or along a vertical axis. In addition, the printing head 40 may rotate about the lateral axis, about the longitudinal axis, and/or about the vertical axis. Similarly, the platen 34 may translate along the lateral axis, along the longitudinal axis, and/or along the vertical axis, and/or rotate about the lateral axis, about the longitudinal axis, and/or about the vertical axis. In certain exemplary embodiments, the platen 34 may be stationary and the printing head 40 may be movable. In further exemplary embodiments, the printing head 40 may be stationary and the platen 34 may be movable. In other exemplary embodiments, both the printing head 40 and the platen 34 may be movable (e.g., along or about at least one axis). Any suitable drive mechanism (e.g., electric motor, pneumatic motor, hydraulic motor, linear actuator, etc.) may be employed to move the printing head 40 and/or the platen 34.

According to an exemplary embodiment, the support surface 38 of the platen 34 includes a substantially flat central portion 62, a first contoured portion 64, and a second contoured portion 66. The shape of the platen support surface 38 establishes the shape of the show surface 39 of the trim component. Accordingly, the illustrated trim component 32 includes a flat central portion and a contoured portion on each lateral side of the flat portion. The platen support surface may have other shapes in alternative exemplary embodiments (e.g., depending on the desired shape of the trim component). For example, while the illustrated platen 34 includes two contoured portions 64 and 66, it should be appreciated that alternative platens may include more or fewer contoured portions. In addition, in certain exemplary embodiments, the contoured portions of the platen may include simple and/or complex curves, facilitating formation of a multidimensional show surface of the trim component. In further exemplary embodiments, the support surface 38 of the platen may be substantially flat to form a substantially flat trim component. The support surface 38 of the platen 34 may be smooth or textured to establish a desirable surface finish of the show surface 39.

According to an exemplary embodiment, the substrate 49 of the trim component 32 includes bosses 68, e.g., to facilitate mounting the trim component 32 within the vehicle interior 12. The bosses 68 are formed by building up filaments or layers of material in a desired pattern. In certain exemplary embodiments, the additive manufacturing device 30 may be configured to form ribs, bosses, and/or brackets on the substrate 49. In addition, the additive manufacturing device 30 may be configured to form the substrate into a desired shape to establish a desired structural rigidity and/or to facilitate installation within a selected region of the vehicle interior.

In certain exemplary embodiments, the decorative layer 36 extends along a portion of the platen 34, establishing a desired coverage of the decorative layer 36 on the substrate 49. For example, the decorative layer 36 may be positioned and/or oriented on the platen 34 to form a show surface on a desired region of the trim component. In further exemplary embodiments, the decorative layer 36 extends beyond the platen 34, covering a desired portion of the substrate 49. An excess portion 70 of the decorative layer 36, which extends beyond the platen, may be removed from the vehicle trim component 32 (e.g., after the component is removed from the platen). For example, in certain exemplary embodiments, the excess portion 70 of the decorative layer 36 may be trimmed to establish an aesthetically desirable edge of the trim component. In further exemplary embodiments, the decorative layer 36 may include a transfer foil configured to be peeled away from the completed trim component 32, leaving a decorative coating on the substrate 49. In certain exemplary embodiments, the decorative layer 36 may include a laminate film, a transfer foil, a fabric covering, a leather covering, a polymeric covering, a wood veneer, a metal sheet, and/or a flex circuit, among others.

According to an exemplary embodiment, the manufacturing device includes an attachment device to secure the cover to the plate. According to exemplary embodiments, the attachment device can comprise at least one of an adhesive layer, a vacuum, an electrostatic charging assembly, and/or a magnetic assembly.

According to an exemplary embodiment, the attachment device includes a vacuum assembly 72 configured to secure the decorative layer 36 to the platen 34 of an additive manufacturing device 30 via a differential pressure. The vacuum assembly 72 includes a vacuum pump 74 and multiple conduits 76 extending between the vacuum pump 74 and respective orifices 78 within the support surface 38 of the platen 34. Upon activation of the vacuum pump 74, air pressure adjacent to the show surface 39 is reduced. As a result, air pressure adjacent to the rear surface 44 of the decorative layer 36 drives the decorative layer 36 into contact with the support surface 38 of the platen 34. After the additive manufacturing process is complete, the vacuum pump 74 may be deactivated, facilitating removal of the trim component 32 from the platen 34. Accordingly, the vacuum assembly 72 secures the decorative layer 36 to the platen 34 at least while the printing head 40 disposes material 42 onto the rear surface 44 of the decorative layer 36. In certain exemplary embodiments, the vacuum assembly 72 may remain activated until the material 42 cools, substantially reducing or eliminating the possibility of the component warping during the cooling process. While the illustrated exemplary embodiment includes a vacuum assembly 72 to secure the decorative layer to the platen, it should be appreciated that alternative exemplary embodiments may include other attachment devices (e.g., an adhesive layer, an electrostatic charging assembly, and/or a magnetic assembly, among other mechanical and/or electromagnetic attachment devices).

To form the vehicle interior component, the show surface 39 of the decorative layer 36 is applied to the support surface 38 of the platen 34. The vacuum assembly 72 is then activated to secure the decorative layer 36 to the platen 34. Next, the printing head 40 disposes material 42 onto the rear surface 44 of the decorative layer 36 to form the vehicle trim component 32. The vacuum assembly 72 is then deactivated, and the trim component 32 is removed from the platen 34. According to an exemplary embodiment, after removal of the trim component, a portion of at least one of the first material layer and/or the second material layer can be removed. According to an exemplary embodiment, the excess portion 70 of the decorative layer 36 is removed (e.g., trimmed, peeled, etc.) from the trim component. Forming the substrate 49 behind the decorative layer 36 substantially reduces the duration and/or costs associated with manufacturing an aesthetically desirable trim component, as compared to applying a decorative layer to a preformed substrate. Because the decorative layer is exposed to lower temperatures and/or pressures than an in-mold decoration of an injection molding process, manufacturing the trim component by an additive manufacturing process facilitates use of additional types of decorative layers. For example, the lower temperatures and/or pressures of the additive manufacturing process may facilitate use of a cover such as a laminate film covering or decorative layer, a transfer foil covering or decorative layer, a fabric covering or decorative layer, a leather covering or decorative layer, a wood veneer covering or decorative layer, a polymeric covering or decorative layer, and/or a flex circuit covering or decorative layer, among other coverings or decorative layers.

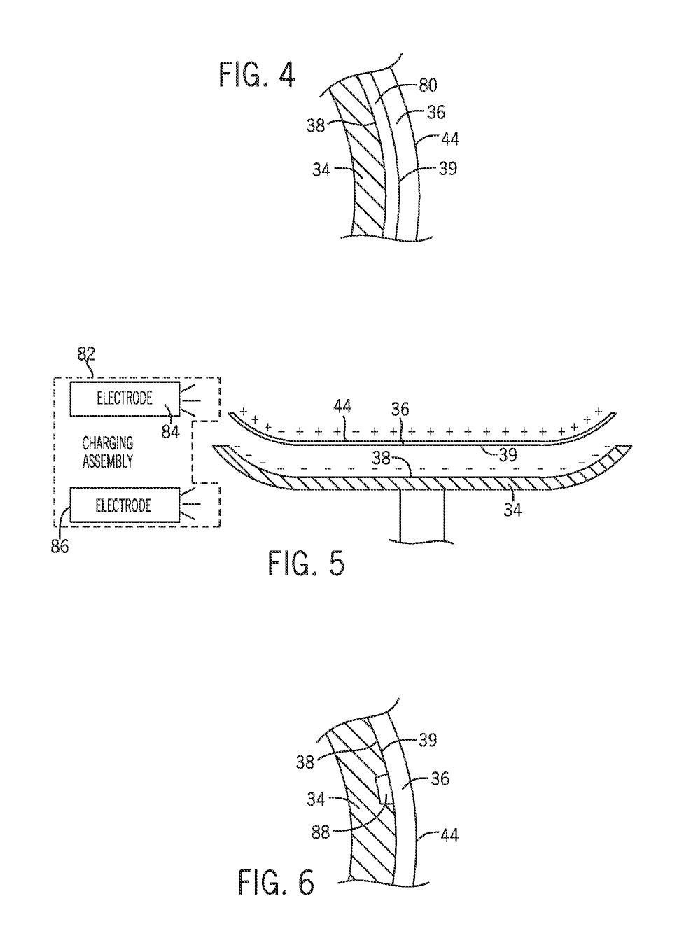

FIG. 4 is a schematic cross-sectional view of an exemplary embodiment of a platen 34 of an additive manufacturing device, including an adhesive layer 80 configured to secure a decorative layer 36 to the platen 34. The adhesive layer 80 is configured to secure the decorative layer to the platen at least while the printing head 40 disposes material 42 onto the rear surface 44 of the decorative layer 36. For example, prior to manufacturing the vehicle trim component, the adhesive layer 80 may be applied to at least a portion of the support surface 38 of the platen 34. The show surface 39 of the decorative layer 36 may then be placed into contact with the adhesive layer 80, securing the decorative layer 36 to the platen 34. After the vehicle trim component is formed (e.g., after the material cools), the component may be removed from the platen (e.g., via application of force and/or heat). For example, the bond between the substrate 49 and the decorative layer 36 may be significantly stronger than the bond formed by the adhesive layer 80. Accordingly, the trim component may be readily removed from the platen while maintaining the integrity of the component.

FIG. 5 is a schematic view of an exemplary embodiment of an electrostatic charging assembly 82 configured to facilitate securing a decorative layer 36 to a platen 34 of an additive manufacturing device. The electrostatic charging assembly 82 is configured to induce a first electric charge within the decorative layer 36 and to induce a second electric charge within the platen 34. For example, the electrostatic charging assembly 82 may induce a positive electric charge within the decorative layer 36 and a negative electric charge within the platen 34, establishing an electrostatic attraction between the decorative layer 36 and the platen 34. The magnitude of the electrostatic attraction may be modified (e.g., by adjusting the magnitude of the first and second electric charges) to secure the decorative layer 36 in a desired position and/or orientation on the platen 34 at least until the substrate is formed. As a result, the decorative layer 36 may be secured to the platen 34 during the additive manufacturing process.

According to an exemplary embodiment, the electrostatic charging assembly 82 includes a first electrode 84, such as a corona-charging electrode, configured to induce an electric charge within the decorative layer 36, and a second electrode 86, such as a corona-charging electrode, configured to induce an electric charge within the platen 34. Corona-charging electrodes are configured to bombard a target object with ions (charged particles), inducing a charge within the target object. According to an exemplary embodiment, the first corona-charging electrode 84 is configured to induce a positive charge within the decorative layer 36, and the second corona-charging electrode 86 is configured to induce a negative charge within the platen 34. However, the first corona-charging electrode 84 may induce a negative charge within the decorative layer 36, and the second corona-charging electrode 86 may induce a positive charge within the platen 34. While corona-charging electrodes 84 and 86 are employed in the illustrated exemplary embodiment, alternative exemplary embodiments may include other electrostatic charging devices to induce the desired charges.

In certain exemplary embodiments, the electrostatic charging assembly 82 is configured to induce the electric charges within the decorative layer 36 and within the platen 34 prior to application of the decorative layer to the platen. For example, the electrostatic charging assembly 82 may be activated to induce the desired charges, and then deactivated once a desired magnitude of the charges is achieved. The decorative layer 36 is then placed in contact with the platen 34 at a desired position and/or orientation. Electrostatic attraction between the decorative layer 36 and the platen 34 holds the decorative layer in the desired position and/or orientation at least until the additive manufacturing device completes formation of the substrate. The bond between the substrate 49 and the decorative layer 36 may be significantly stronger than the electrostatic attraction between the decorative layer and the platen. Accordingly, the trim component may be readily removed from the platen (e.g., after the material cools) while maintaining the integrity of the component.

FIG. 6 is a schematic cross-sectional view of an exemplary embodiment of a platen 34 of an additive manufacturing device, including a magnetic assembly configured to secure a decorative layer 36 to the platen 34. The magnetic assembly, such as the illustrated magnet 88, is configured to secure the decorative layer in a desired position and/or orientation on the platen 34. For example, a ferromagnetic material or another magnetic material within the decorative layer may be magnetically attracted to the magnet 88, facilitating attachment of the decorative layer to the platen. In certain exemplary embodiments, the decorative layer 36 may be formed from a sheet of ferromagnetic material, such as stainless steel. The magnitude of the magnetic attraction may be modified (e.g., by adjusting the strength of the magnet) to secure the decorative layer 36 in the desired position and/or orientation on the platen 34 at least until the substrate is formed. As a result, the decorative layer 36 may be secured to the platen 34 during the additive manufacturing process.

As used in this description, the term “ferromagnetic” refers to any material that is attracted to a magnetic field. Accordingly, ferromagnetic materials include materials that may be considered ferrimagnetic. By way of example, ferromagnetic materials include iron, nickel, cobalt, compounds formed from certain rare earth elements, and various metallic alloys. However, it should be appreciated that any suitable ferromagnetic material may be utilized within the decorative layer 36.

It should be appreciated that the magnet 88 may be permanently magnetic or electromagnetic. For example, one or more permanent magnets may be embedded within the platen 34. An operator or an automated system may place the decorative layer 36 in contact with the platen 34. Magnetic attraction between the magnet 88 and a ferromagnetic material and/or another magnet within the decorative layer 36 holds the decorative layer in the desired position and/or orientation at least while the printing head disposes the material onto the rear surface of the decorative layer. The bond between the substrate 49 and the decorative layer 36 may be significantly stronger than the magnetic attraction between the decorative layer and the platen. Accordingly, the trim component may be readily removed from the platen while maintaining the integrity of the component.

According to an exemplary embodiment, one or more electromagnets may be positioned to hold the decorative layer to the platen. In certain exemplary embodiments, the electromagnets may be activated prior to placement of the decorative layer on the platen. The electromagnet may remain magnetized through the additive manufacturing process. Once formation of the substrate is complete, the electromagnet may be deactivated to facilitate removal of the vehicle trim component from the platen. In certain exemplary embodiments, the electromagnet may remain activated until the material 42 cools, thereby substantially reducing or eliminating the possibility of the component warping during the cooling process.

While the illustrated exemplary embodiment includes a discrete magnet 88 embedded within the platen 34, in other exemplary embodiments, the entire platen 34, or a portion of the platen 34, may be magnetized. In further exemplary embodiments, at least a portion of the platen 34 may include a ferromagnetic material, and the decorative layer 36 may include a magnet. In such exemplary embodiments, the decorative layer 36 may be secured to the platen 34 by magnetic attraction between the magnet and the ferromagnetic material. For example, the entire platen may be formed from a ferromagnetic material. Alternatively, the platen may include a ferromagnetic portion configured to secure the decorative layer to the platen.

The described attachment devices, for example, adhesive layer, vacuum, electrostatic charging assembly, and magnetic assembly, can be used in a variety of manufacturing devices and processes, according to exemplary embodiments of the invention.

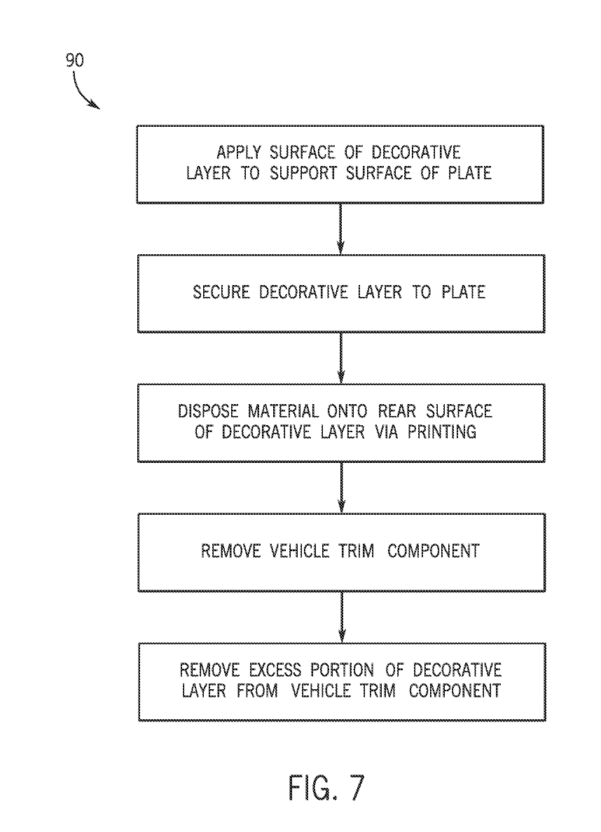

FIG. 7 is a schematic process flow diagram of an exemplary embodiment of a method 90 of manufacturing a vehicle trim component via a manufacturing process, such as additive manufacturing. First, a surface of a cover, such as a show surface of a decorative layer, is applied to a support surface of a plate of a manufacturing device, such as a platen of an additive manufacturing device. Next, the decorative layer is secured to the platen via an attachment device. For example, the attachment device may include an adhesive layer, a vacuum assembly configured to secure the decorative layer to the platen via a pressure differential, an electrostatic charging assembly configured to facilitate securing the decorative layer to the platen via electrostatic attraction, and/or a magnetic assembly configured to secure the decorative layer to the platen via magnetic attraction. Material is then disposed onto the rear surface of the decorative layer via printing, for example by a printing head, to form the vehicle trim component. According to an exemplary embodiment, the printing head may include an extrusion nozzle configured to dispose multiple filaments of material onto the rear surface of the decorative layer.

After the trim component is formed by the manufacturing process, the trim component is removed, for example, removed from the platen. Finally, an excess portion of the decorative layer is removed (e.g., trimmed, peeled, etc.) from the vehicle trim component, forming an aesthetically desirable edge of the trim component. For example, in certain exemplary embodiments, the decorative layer may include a transfer foil configured to be peeled away from the completed trim component, leaving a decorative coating on the substrate. Forming the substrate behind the decorative layer substantially reduces the duration and/or costs associated with manufacturing an aesthetically desirable trim component, as compared to applying a decorative layer to a preformed substrate. In addition, because the decorative layer is exposed to lower temperatures and/or pressures than an in-mold decoration of an injection molding process, manufacturing the trim component by the additive manufacturing process facilitates use of additional types of decorative layers. For example, the lower temperatures and/or pressures of the additive manufacturing process may facilitate use of a leather decorative layer, a wood veneer decorative layer, and/or a flex circuit decorative layer, among other decorative layers.

An aspect of the disclosure relates to a system and method for forming a vehicle trim component via additive manufacturing, and a vehicle trim component. According to an exemplary embodiment, a method of manufacturing a vehicle trim component 32 includes applying a show surface 39 of a decorative layer 36 to a support surface 38 of a platen 34 of an additive manufacturing device 30. The method also includes disposing material 42 onto a rear surface 44 of the decorative layer via a printing head 40 of the additive manufacturing device to form the vehicle trim component.

According to an exemplary embodiment, a method of manufacturing a vehicle trim component, comprises: applying a show surface of a decorative layer to a support surface of a platen of an additive manufacturing device; and disposing material onto a rear surface of the decorative layer via a printing head of the additive manufacturing device to form the vehicle trim component. According to an exemplary embodiment of the method, the printing head comprises an extrusion nozzle configured to dispose multiple filaments of the material onto the rear surface of the decorative layer. According to an exemplary embodiment of the method, the printing head, the platen, or a combination thereof, is movable along or about at least one axis. According to an exemplary embodiment of the method, the support surface of the platen includes at least one contoured portion. According to an exemplary embodiment of the method, the decorative layer comprises a laminate film, a transfer foil, a fabric covering, a leather covering, a polymeric covering, a wood veneer, a metal sheet, a flex circuit, or a combination thereof. According to an exemplary embodiment of the method, the method comprises securing the decorative layer to the platen via an attachment device prior to disposing the material onto the rear surface of the decorative layer. According to an exemplary embodiment of the method, the attachment device comprises an adhesive layer. According to an exemplary embodiment of the method, the attachment device comprises a vacuum assembly configured to secure the decorative layer to the platen via a pressure differential. According to an exemplary embodiment of the method, the attachment device comprises an electrostatic charging assembly configured to facilitate securing the decorative layer to the platen via electrostatic attraction, or a magnetic assembly configured to secure the decorative layer to the platen via magnetic attraction. According to an exemplary embodiment of the method, the method comprises: removing the vehicle trim component from the platen; and removing an excess portion of the decorative layer from the vehicle trim component.

According to an exemplary embodiment, a vehicle trim component is described that can be prepared by a process, comprising: applying a show surface of a decorative layer to a support surface of a platen of an additive manufacturing device; and disposing material onto a rear surface of the decorative layer via a printing head of the additive manufacturing device to form the vehicle trim component. According to an exemplary embodiment of the vehicle trim component, the decorative layer comprises a laminate film, a transfer foil, a fabric covering, a leather covering, a polymeric covering, a wood veneer, a metal sheet, a flex circuit, or a combination thereof. According to an exemplary embodiment of the vehicle trim component, the process comprises securing the decorative layer to the platen via an attachment device prior to disposing the material onto the rear surface of the decorative layer. According to an exemplary embodiment of the vehicle trim component, the support surface of the platen includes at least one contoured portion. According to an exemplary embodiment of the vehicle trim component, the process for preparing the vehicle trim component comprises removing the vehicle trim component from the platen; and removing an excess portion of the decorative layer from the vehicle trim component.

According to an exemplary embodiment, an additive manufacturing device for forming a vehicle trim component, comprises: a platen configured to support a decorative layer via contact between a support surface of the platen and a show surface of the decorative layer; a printing head configured to dispose material onto a rear surface of the decorative layer to form the vehicle trim component; and an attachment device configured to secure the decorative layer to the platen at least while the printing head disposes the material onto the rear surface of the decorative layer. According to an exemplary embodiment of the additive manufacturing device, the printing head comprises an extrusion nozzle configured to dispose multiple filaments of the material onto the rear surface of the decorative layer. According to an exemplary embodiment of the additive manufacturing device, the printing head, the platen, or a combination thereof, is movable along or about at least one axis. According to an exemplary embodiment of the additive manufacturing device, the support surface of the platen includes at least one contoured portion. According to an exemplary embodiment of the additive manufacturing device, the attachment device comprises an adhesive layer, a vacuum assembly configured to secure the decorative layer to the platen via a pressure differential, an electrostatic charging assembly configured to facilitate securing the decorative layer to the platen via electrostatic attraction, or a magnetic assembly configured to secure the decorative layer to the platen via magnetic attraction.

While only certain features and exemplary embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. The appended claims are intended to cover all such modifications and changes as fall within the true spirit of the invention. In an effort to provide a concise description of the exemplary embodiments, all features of an actual implementation may not have been described (i.e., those unrelated to the presently contemplated best mode of carrying out the invention, or those unrelated to enabling the claimed invention). In the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

What is claimed is:

1. A vehicle trim component prepared by a process comprising:
providing a cover on a plate;
providing a first material layer on the cover;
providing a second material layer on the first material layer to form the vehicle trim component;
wherein the first material layer bonds to the cover as it solidifies; and
wherein the second material layer bonds to the first material layer as it solidifies.

2. The vehicle trim component of claim 1 wherein the second material layer comprises multiple material layers.

3. The vehicle trim component of claim 1 wherein the first material layer and the second material layer comprise heated liquids.

4. The vehicle trim component of claim 1 wherein the first material layer and the second material layer comprise filaments.

5. The vehicle trim component of claim 1 wherein the first material layer and the second material layer comprise at least one of (a) a polymeric material, (b) a two-part reactive material, (c) a polyisocyanate, (d) a polyol, (e) a thermoset polymer, (f) a polyurethane, (g) acrylonitrile butadiene styrene, (h) polycarbonate, (i) polyethylene (HDPE).

6. The vehicle trim component of claim 1 wherein the cover comprises at least one of (a) a laminate film, (b) a transfer foil, (c) a fabric covering, (d) a leather covering, (e) a polymeric covering, (f) a wood veneer, (g) a metal sheet, (h) a flex circuit.

7. The vehicle trim component of claim 1 wherein the vehicle trim component comprises a shape configured for at least one of (a) structural rigidity, (b) installation of the vehicle trim component.

8. The vehicle trim component of claim 1 wherein the plate is configured to establish a shape of the vehicle trim component.

9. The vehicle trim component of claim 1 wherein the cover comprises a decorative layer and the plate comprises a platen.

10. A method of manufacturing a vehicle trim component comprising:
providing a cover on a plate;
providing a first material layer on the cover;
providing a second material layer on the first material layer to form the vehicle trim component;
wherein the first material layer bonds to the cover as it solidifies; and
wherein the second material layer bonds to the first material layer as it solidifies.

11. The method of claim 10 wherein providing the second material layer on the first material layer comprises building up at least one of (a) filaments, (b) layers in a pattern.

12. The method of claim 10 wherein the first material layer and the second material layer are provided by at least one of (a) an extrusion device, (b) a laminated object manufacturing device, (c) a printing head of an additive manufacturing device.

13. The method of claim 10 further comprising securing the cover to the plate via an attachment device.

14. The method of claim 13 wherein the attachment device comprises at least one of (a) an adhesive layer, (b) a vacuum, (c) an electrostatic charging assembly, (d) a magnetic assembly.

15. The method of claim 10 further comprising:
removing the vehicle trim component from the plate; and
removing a portion of at least one of (a) the first material layer, (b) the second material layer from the vehicle trim component.

16. The method of claim 10 wherein the plate comprises a platen.
